(19) United States
(12) Patent Application Publication
(10) Pub. No.: US 2010/0224205 A1
(43) Pub. Date: Sep. 9, 2010

(54) DEVICE AND METHODS FOR MODIFYING KERATINOUS SURFACES

(76) Inventors: Shekhar Mitra, Indian Hill, OH (US); Thomas Elliot Rabe, Baltimore, MD (US); David Edward Wilson, Reisterstown, MD (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/632,850

(22) Filed: Dec. 8, 2009

Related U.S. Application Data
(60) Provisional application No. 61/121,070, filed on Dec. 9, 2008.

(51) Int. Cl. A61Q 5/00; A45D 44/00

(52) U.S. Cl. 132/202; 132/221

(57) ABSTRACT

An apparatus for modifying a keratinous surface having an applicator, a first modification agent; a sensor; and a CPU. The sensor reads the properties of a small portion of the keratinous surface, the readings are transmitted to the CPU, and the CPU compares the readings to a predetermined baseline value. The CPU then calculates the variance between the reading and the baseline value. When that variance exceeds a predetermined threshold the CPU sends a signal to the applicator which is activated to apply a portion of the first modification composition to the same portion of the keratinous surface that had the reading with a variance above the threshold value.

### CROSS REFERENCE TO RELATED APPLICATION

This application claims the benefit of provisional application number 61/121,070, filed Dec. 9, 2008.

### FIELD OF THE INVENTION

This invention relates to a device for applying compositions to hair shafts. The compositions can modify color or structure of the hair. Structure modifications can include complete removal of the hair from human skin.

### BACKGROUND OF THE INVENTION

Hair coloring, hair growth compositions and hair removal compositions are known. But all of them share a common defect; they are exceedingly difficult to apply with precision. Hair removal compositions, commonly referred to as depilatories, are generally harsh chemicals. They are designed to be applied to unwanted hair. Depilatories remove the hair by essentially dissolving it. But existing technologies apply the depilatories to both the hair and the skin around the hair. This can result in irritation to the skin. Alternatively, formulators can make a depilatory that is not harsh to the skin, but this invariably makes the depilatory less effective.

Likewise, hair colorants are generally applied to the hair but necessarily they contact the skin around the hair. While hair colorants are often less offensive to the skin than are depilatories, they are harsh and can modify the color of the skin. Hair colorants are typically thick viscous compositions that are applied in bulk to hair in hopes that the composition will stick to the hair shafts and color the desired area. But it would be advantageous if a more precise method of application were available such that less viscous colorant can be used in smaller amounts to more precisely color only the desired area.

Finally, hair growth compositions are essentially poured onto the scalp in hopes that some will leach into the follicle pores were it is needed. Again, if a more precise method of application were available, small amounts of the hair growth composition could be directed to the pores where it is needed without drenching the entire scalp.

Therefore, there exists a need for methods and apparatuses that can precisely apply liquid compositions to small areas such as very fine facial hair, a portion of a hair shaft, or the pores of a hair follicle. These methods and apparatuses are defined by the present invention.

### SUMMARY OF THE INVENTION

In one embodiment of the present invention there is provided an apparatus for modifying a keratinous surface comprising an applicator; a first modification agent; a sensor; and a CPU. The sensor reads the properties of a small portion of the keratinous surface, the readings are transmitted to the CPU, the CPU compares the readings to a predetermined baseline value and calculates the variance between the reading and the baseline value. When that variance exceeds a predetermined threshold the CPU sends a signal to the applicator which is activated to apply a portion of the first modification composition to the same portion of the keratinous surface that had the reading with a variance above the threshold value. The keratinous surface can be selected from the group consisting of a hair shaft, a hair pore and mixtures thereof. The first modification agent can be a hair removal composition, a hair growth composition a hair colorant composition and the like. The readings made by the sensor may contain a value for a characteristic selected from the group of color, texture, and mixtures thereof.

In yet another embodiment of this invention there is provided a method for modifying a keratinous surface comprising the steps of: providing a sensor that reads the properties of a small portion of the keratinous surface; sending the readings to a CPU, which is programmed with a predetermined baseline value and at least one predetermined threshold value. The CPU compares the readings to the baseline value and calculates the variance between the reading and the baseline value. When that calculated variance exceeds the threshold the CPU sends a signal to an applicator which is activated to apply a portion of a first modification composition to the same portion of the keratinous surface that had the reading with a variance above the threshold value.

The present invention solves many problems with prior devices and methods. Specifically, with the apparatuses and methods of the present invention, the hair colorant, removal and growth compositions can be precisely applied where it is needed. This allows for the use of significantly less composition. Moreover, the surrounding keratinous surfaces that are not treated with the modification agents are not irritated and are not unnecessarily colored.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is apparatus according to the present invention; and

FIG. 2 is a hair shaft.

### DETAILED DESCRIPTION OF THE INVENTION

The present invention may be understood more readily by reference to the following detailed description of illustrative and preferred embodiments. It is to be understood that the scope of the claims is not limited to the specific compositions, methods, conditions, devices, or parameters described herein, and that the terminology used herein is not intended to be limiting of the claimed invention. Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent basis “about,” it will be understood that the particular values form another embodiment. All ranges are inclusive and combinable.

All percentages and ratios used herein are by weight of the total composition, and all measurements made are at 25° C., unless otherwise designated.

The methods, apparatuses, and compositions of the present invention are best understood with reference to the method of use. Each of the process steps, the apparatuses and the compositions used in that step are described in turn below.

First, a potion of a keratinous surface, for example, hair or skin, is read with a sensor. The data from the sensor is analyzed by an analytical device, for example, a CPU. Based on the analysis, the portion of the keratinous analyzed surface is either treated or left untreated by an applicator. The applicator applies a modification composition if the analysis indicates that the surface needs to be treated.

The methods of reading the keratinous surface, the sensors used and the reading the keratinous surface and the analytical equipment are all described in the following published patent applications: WO 2008/098234 A2, Handheld Apparatus and Method for the Automated

Application of Cosmetics and Other Surfaces, first filed 11 Feb. 2007; WO 2008/100878 A1, System and Method for Applying a Modification composition to Change a Person's Appearance Based on a Digital Image, first filed 12 Feb. 2007; WO 2008/098235 A2, System and Method for Providing Simulated Images Through Cosmetic Monitoring, first filed 11 Feb. 2007; WO 2008/100880 A1, System and Method for Applying Agent Electrostatically to Human Skin, first filed 12 Feb. 2007; US 2007/0049832 A1, System and Method for Medical Monitoring and Treatment Through Cosmetic Monitoring and Treatment, first filed 12 Aug. 2005; and US 2007/0035815 A1, System and Method for Applying a Modification composition to Improve the Visual Attractiveness of Human Skin, first filed 12 Aug. 2005; All six applications filed by Edgar et al. The entire disclosure of each of the six Edgar et al. applications is incorporated herein by reference.

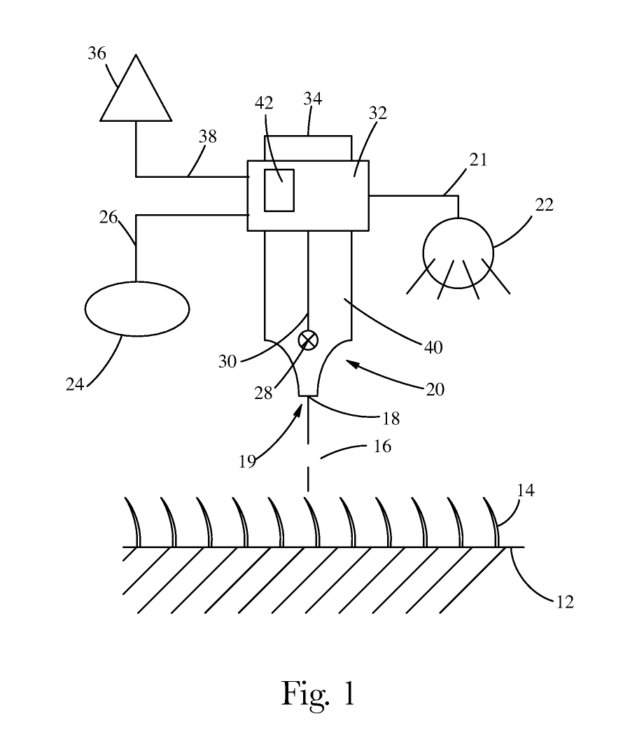

The methods and apparatuses used by the present invention can be briefly summarized as follows. Referring now to FIG. 1, applicator 20 comprises a sensor 24, as described in the six Edgar et al. applications. Sensor 24 analyzes or “reads” a region of keratinous surface, for example, skin 12, hair 14 or both, and divides the reading into a plurality of frexels, and then measures at least one optical attribute of each of the plurality of frexels. From the optical attributes of the frexels, at least one measured characteristic affecting visual attractiveness is identified.

The term “frexel” is defined as a small pixel-like region of the keratinous surface. A frexel might correspond to a small portion of a freckle or other skin feature, or it may correspond to an area of the keratinous surface that does not have special features. The term frexel is used to suggest that what is being measured is on a 3-D surface rather than a flat surface. A region of keratinous surface is comprised of a plurality of frexels. For instance, if a resolution of 300 dots per inch (11.8 dots per mm or “dpmm”) is used, a frexel may have a width and height of about 1/300th of an inch (0.085 mm) so that there are approximately 90,000 frexels per square inch (140 frexels per square mm) The surface of the human body may have millions of frexels.

Sensor 24 is in electronic communication with CPU 32 via optional sensor lead 26. Wireless communication between any or all of the electronic elements is acceptable and may be preferred in certain embodiments. The reading from sensor 24 is transmitted to CPU 32 and a desired state of the skin characteristic is determined based on a predetermined look for the characteristic read. A signal may be sent to valve 28 via optional valve lead 30 which actuates the valve to dispense at least one modification composition 16 to specific frexels in order to modify the measured skin characteristic to approach the desired state of the keratinous surface characteristic. Modification composition 16 is contained in reservoir 40 and can be dispensed through opening 18.

Other optional components include, but are not limited to, light source 22, light source lead 21, power source 42 and switch 34 to turn the device on and off. In a preferred embodiment of the present inventions motion sensor 36 is used to determine the speed that applicator 20 is moving across the keratinous surface, what angle it is in relation to the keratinous surface and how far away from the keratinous surface it is. All of these dimensions can be used to more accurately and more selectively deposit to modification composition 16.

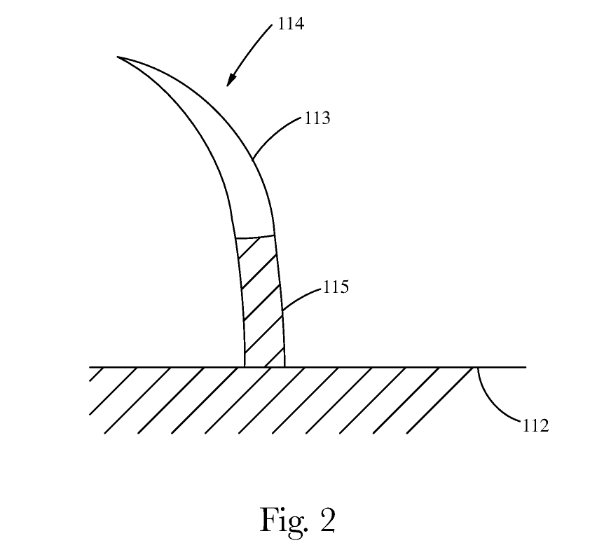

Referring now to FIG. 2, which illustrates hair 114 extending above skin 112. Hair 114 has an end color region 113 and a root color region 115. While there can be more than two color regions, two are shown for simplicity. In one embodiment, the apparatuses of the present invention can be programmed to read the different colors of a hair follicle and selectively apply a modification agent, for example a colorant, to only the portion of the hair shaft that needs to be modified. Likewise, the apparatus can identify different colors between strands of hair. For example, the apparatus can be programmed to identify grey hairs, and apply a modification agent only to the grey hair. In this instance the entire shaft of the hair needing modification is covered, while the surrounding hairs are not so modified. Moreover, the apparatus can apply multiple modification agents and apply them in a preprogrammed pattern. This would be useful in “streaking” hair with multiple different colors while optionally leaving some strand unmodified.

The programming of CPU 32 will be know to those skilled in the art. But the logic will include identifying a desired baseline. In the case of hair colorants, the baseline can be the desired color of hair. For hair removal applications, the baseline can be skin with no hair on it. In the case of hair growth agents, the baseline can be the pores from which hair grows. The threshold value can be a certain deviation from the baseline that requires correction. For hair color applications the threshold will be a change in color from the baseline indicating that the analyzed area of hair needs the hair colorant to be applied. Likewise, for hair removal, the texture of the skin can be measured and the change in texture will indicate the presence of an unwanted hair to which the hair removal composition is applied.

In yet another embodiment the apparatuses of this invention can be programmed to distinguish between different keratinous surfaces. As shown in FIG. 1, hair 14 emanating from skin 12 can be selectively targeted with modification compositions. As can be seen in the Examples below, hair colorants and hair removal compositions often contain compounds that are harsh to skin. Thus the ability to apply modification compositions to a hair shaft, while minimizing the amount contacting the skin can substantially improve the consumer experience.

Finally, the apparatuses of this invention can be programmed to read skin 12 looking for pores that should contain hair shafts, contain unhealthy hair shafts, or contain hair shafts in an area of the scalp where hair loss is likely to occur (e.g. areas of male pattern baldness). The apparatus can apply a modification agent into the pore which can be, for example, a hair growth stimulant (such as the commercially available minoxidil). By this method, higher concentrations of the modification agent can be applied selectively to the exact area where it is needed.

Apparatus 10 is preferably handheld but can be tethered to a structure that moves the apparatus 10 across the keratinous surface to be modified. If handheld, the consumer would simply move apparatus 10 across the keratinous surface to be modified. Optionally, multiple apparatuses can be configured in a stationary structure wherein the consumer places the keratinous surface to be modified and multiple readings and applications occur simultaneously or in sequence.

In another embodiment, the modification agent can be applied to the keratinous surface by scanning and applying almost at the same time and making multiple passes over the surface. Several advantages result from using multiple pass application. The process for multiple pass applications is to make a partial application of the modification agent, then to scan again the area of skin that has received the partial application. A further application of modification agents can be made, and still further multiple pass scanning and applications can be made to approach an aesthetic goal.

Modification agents may be applied with “flow control” devices or non-drop control devices. Flow control devices typically are characterized as “drop control techniques” where individual droplets of the substance are controlled. Ink jet printers, which are known to the art, are examples of drop on demand applicators and this technology is applicable for use n the present invention. Spray devices and electrostatic spray devices are non-drop control techniques where droplets are produced and controlled only in aggregate. Often in a spray device, a lack of individual droplet control, or “randomness” is desired in order to produce a smooth application over a relatively large area. By contrast, it is often desirable to provide very specific control of the amount and placement of the modification agents.

Examples of drop control include “fine flow control” where the flow of the substance is precisely controlled to deliver droplets as desired; and “inkjet technologies.” An older inkjet technology includes supplying a continuous flow of charged droplets past electrostatic deflector plates which are alternately charged so that the plates either permit a droplet to pass or deflect to a gutter. This technique was the original design basis for inkjet printers. Other inkjet technologies include “drop on demand” such as thermal devices provided by Hewlett Packard, and piezoelectric devices such as provided by Epson and other printer manufacturers. In one embodiment of the current invention, the drop on demand technology is combined with charging the droplets.

In the current invention the older inkjet technology can be used to deliver charged droplets in a scanned direction beam. Modern inkjet printers have been optimized for printing on flat surfaces over limited distances. The current invention prints on keratinous surfaces which are dimensional, and often require a greater throw distance for the droplets. This greater throw distance can be facilitated with the better droplet aiming than is possible with a charged droplet. For example, drop on demand technology may be used to apply a single droplet of white pigment to spot in the face with pixel-level precision.

### Modification Agents

The present invention may utilize a variety of modification agents, but the primary focus is on hair colorants, hair removal compositions (often referred to as depilatories), and hair growth stimulants. These compositions, and there component parts, are best described by the examples given below. Each of the individual chemical compositions described below for hair colorants can be used in combination with any of the others ingredients, and likewise, those skilled in the art will appreciate that the individual compositions given for depilatories can be used with other ingredients listed in other examples.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

Hair Colorant Modification Agents

Hair colouring compositions generally comprise an oxidising agent, and a developer. Optionally, a coupler may be used. Various aromatic compounds can be used as developers (also known as precursors or primary intermediates), together with various other compounds, commonly known as couplers. These are referred to as oxidative hair colouring agents because they require an oxidising agent for formation of colour. The compounds described as developers are those which react with oxidising agent to form a reactive oxidised intermediate. This intermediate then reacts with the coupler or couplers to give a coloured molecule. Some developers are capable of reacting with another molecule of the same type, i.e. self-coupling. Couplers do not generally react with oxidising agent but instead react with the reactive oxidised intermediate formed by reaction between the developer and the oxidising agent. According to this invention hair colouring compositions comprise:

(i) at least one developer; and

(ii) at least one oxidising agent; and

(iii) optionally, at least one coupler.

Couplers, developers and oxidizing agents are generally described in WO98/52522 and U.S. Pat. Nos. 7,066, 962, 6,432,147, the entire disclosure of these three references are incorporated herein by reference. Couplers can be used in amounts of from for instance 0.01 to 4%, preferably 0.01 to 2%, more preferably 0.03 to 3, eg 0.03 to 2%, and in some compositions not more than 1 or 0.5%. Total levels of developer and coupler generally vary according to the shade required. For blonde shades amounts of from 0.001 to 4 wt. % are preferred. For red shades amounts of 0.001 to 4 wt. % are preferred. For brown shades amounts of 0.01 to 4% are preferred. For black shades amounts of 0.1 to 4 wt. % are preferred.

A preferred oxidising agent is hydrogen peroxide. This is often used in amounts up to 10 wt. %, based on weight of composition applied to the hair. Other oxidising agents which may be used include other inorganic peroxygen oxidising agents, preformed organic peroxyacid oxidising agents and other organic peroxides such as urea peroxide, melamine peroxide, and mixtures of any of these.

Suitable oxidising agents are preferably water-soluble, that is they have a solubility of at least about 5 g in 1,000 ml of deionised water at 25° C. (‘Chemistry’ C. E. Mortimer, 5th Edition, page 277).

Usually the colouring compositions of the invention have pH above 7, in particular above pH 8 or 9. A pH of from 9 to 12 is often suitable. The systems of the invention can also be incorporated into low pH (eg pH 1 to 6) hair colouring systems.

### Example 1

The following composition shown in Table 1 can be used for dyeing Piedmont hair. 100 g of the dyeing composition is mixed with 100 g of 20 volume hydrogen peroxide. The resulting mixture is applied to the hair and permitted to remain in contact with the hair for 30 minutes. The dyed hair is then shampooed, rinsed with water and dried. The ranges of ingredients set out in Table 1 are illustrative of useful concentrations of the recited materials in a hair dye product.

TABLE 1
Composition for Dyeing Hair

| Ingredients | Range (wt %) | Weight (%) |
|---|---|---|
| Cocamidopropyl betaine | 0-25 | 17.00 |
| Polyquaternium-22 | 0-7 | 5.00 |
| Monoethanolamine¹ | 0-15 | 2.00 |
| Oleic Acid | 2-22 | 0.75 |
| Citric Acid | 0-3 | 0.10 |
| 28% Ammonium hydroxide¹ | 0-15 | 5.00 |
| Behentrimonium chloride | 1-5 | 0.50 |
| Sodium sulfite | 0-1 | 0.10 |
| EDTA | 0-1 | 0.10 |
| Erythorbic acid | 0-1 | 0.40 |
| Ethoxydiglycol | 1-10 | 3.50 |
| C11-15 Pareth-9 (Tergitol 15-S-9) | 0.5-5 | 1.00 |
| C12-15 Pareth-3 (Neodol 25-3) | 0.25-5 | 0.50 |
| Isopropanol | 2-10 | 4.00 |
| Propylene glycol | 1-12 | 2.00 |
| p-Phenylenediamine² | 0-5 | 2 mmoles |
| N,N-Bis(hydroxyethyl)-p-phenylene | 0-5 | 2 mmoles |
| diamine² | | |
| 3-Methyl-p-aminophenol² | 0-5 | 1 mmoles |
| p-Aminophenol² | 0-5 | 2 mmoles |
| Coupler* | 0.5-5 | 4 mmoles |
| 5-Amino-2-Methyl Phenol | 0-5 | 1 mmoles |
| 2,4-Diaminophenoxyethanol | 0-5 | 1 mmoles |
| m-Phenylenediamine | 0-5 | 1 mmoles |
| Water | qs to 100.00 | qs to 100.00 |

¹In the aggregate, these ingredients are in the range of 2 to 15% by weight.
²At least one of these dye precursors is typically present.
*Couplers were chosen depending on the desired hair color from the group consisting of: 3-(N-acetyl) amino-1-phenol-2-pyrazolin-5-one (NAPP); 2,6-dichloro-para-aminophenol (DCP); paraphenylene diamine (PPD); 1.2% 3-acetamido phenol (3AP); and mixtures thereof.

Hair Removal Compositions

Numerous hair removal compositions are exemplified below. Typically these compositions contain two general components: a carrier and an active. Common carriers can be selected from the group consisting of water, alcohols, glycols, glycerin and mixturese thereof. The actives are best described by the various examples given below.

### Example 2

A topical composition is prepared by combining the following components utilizing conventional mixing techniques and the pH is adjusted to 6.0 by adding NaOH.

| Component | % by wt. |
|---|---|
| N-acetyl-L-cysteine (Active) | 5.0 |
| Propylene glycol | 45.0 |
| Ethanol | 30.0 |
| Water | 20.0 |

1000. mg of the composition per 100 cm² skin is topically applied to the face twice per day to remove unwanted vellus hair.

### Example 3

A topical composition is prepared by combining the following components utilizing conventional mixing techniques and the pH is adjusted to 4.5 by adding NaOH.

| Component | % by weight |
|---|---|
| Thioglycolic acid (Active) | 2.0 |
| Propylene glycol | 57.0 |
| Ethanol | 20.0 |
| Water | 10.0 |
| Benzyl alcohol | 4.0 |
| Glycerin | 5.0 |
| Myristyl alcohol | 2.0 |

4000. mg of the composition per 100 cm² skin is topically applied once a day to the legs to soften terminal hair.

### Example 4

A topical composition is prepared by combining the following components utilizing conventional mixing techniques and the pH is adjusted to about 3.0 by adding NaOH.

| Component | % by weight |
|---|---|
| Glutathione (Active) | 1.0 |
| Propylene glycol | 30.0 |
| Glycerin | 3.0 |
| Water | 66.0 |

2000. mg of the composition per 100 cm² skin is topically applied twice per day to the face to remove unwanted vellus hair.

### Example 5

A topical composition is prepared by combining the following components utilizing conventional mixing techniques and the pH is adjusted to 5.0 by adding NaOH.

| Component | % by weight |
|---|---|
| N-acetyl-L-cysteine (Active) | 0.5 |
| Propylene glycol | 30.0 |
| Propylene glycol laurate | 1.0 |
| Isopropanol | 20.0 |
| Water | 48.5 |

500. mg of the composition per 100 cm² skin is topically applied once per day to the face to remove unwanted vellus hair.

### Example 6

A lotion is prepared by combining the following components utilizing conventional mixing techniques and the pH is adjusted to 4.0 by adding NaOH.

| Component | % by weight |
|---|---|
| Cysteine (Active) | 5.0 |
| Di-partially hydrogenated tallow | 4.0 |
| Cetyltrimethyl ammonium chloride | 2.0 |
| DC-200 fluid (12500 csk)* | 1.0 |
| Citric acid | 3.5 |
| Ethylene glycol distearate | 1.5 |
| PEG-3 C₁₂ alkyl amide | 3.0 |
| Water | 80.0 |

*Dimethylpolysiloxane available from by Dow Chemical Co.

100. mg of the composition per 100 cm² skin is topically applied to the face three times a day to remove unwanted vellus hair.

### Example 7

A water-in-oil emulsion is prepared by combining the following ingredients, using conventional mixing techniques and the pH is adjusted to 6.5 by adding NaOH.

| Component | % by weight |
|---|---|
| Oily Phase | |
| Lipoic acid (Active) | 5.0 |
| Cetearyl alcohol | 5.0 |
| Silicon oil, 200 fluid | 1.0 |
| Isopropyl myristate | 2.0 |
| Sodium stearoyl-2-lactylate | 2.0 |
| Aqueous Phase | |
| Propylene glycol | 5.0 |
| Sodium citrate | 0.2 |
| Perfume | 0.1 |
| Water | 79.7 |

The emulsion is prepared by taking 10 parts of the oily phase and adding it slowly with stirring to 90 parts by volume of the aqueous phase. Use of an amount of the emulsion to deposit about 1000 mg per 100 cm² of the emulsion three times a day to the legs is appropriate, after initial hair is removed by shaving. Replacement terminal hair is softer than the hair removed.

### Example 8

An oil-in-water cream is prepared by mixing the following components and the pH is adjusted to 3.5 by adding NaOH.

| Component | % by weight |
|---|---|
| Oily Phase | |
| N-acetyl-L-cysteine (Active) | 5.0 |
| Sorbitan monoleate | 20.0 |
| Quaternium-18-hectonite | 5.0 |
| Liquid paraffin | 60.0 |
| Aqueous Phase | |
| Xanthan gum 1.0 | 1.0 |
| Preservative | 0.3 |
| Perfume | 0.2 |
| Water | 8.5 |

The cream is prepared by mixing the oily phase and heating to 65° C. The aqueous phase is combined and heated to 70° C. The aqueous phase is added to the oil phase with suitable agitation. Moderate agitation is applied while cooling. About 5 mg of the cream is deposited per 100 cm² on the face once a day to remove unwanted vellus hair.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for modifying a keratinous surface comprising:
an applicator;
a first modification agent;
a sensor;
a CPU;
wherein the sensor reads the properties of a small portion of the keratinous surface, the readings are transmitted to the CPU, the CPU compares the readings to a predetermined baseline value and calculates the variance between the reading and the baseline value and when that variance exceeds a predetermined threshold the CPU sends a signal to the applicator which is activated to apply a portion of the first modification composition to the same portion of the keratinous surface that had the reading with a variance above the threshold value.

2. The device according to claim 1, wherein the keratinous surface is selected from the group consisting of a hair shaft, a hair pore and mixtures thereof.

3. The device according to claim 2, wherein the first modification agent is a hair removal composition.

4. The device according to claim 2, wherein the first modification agent is a hair growth composition.

5. The device according to claim 2, wherein the first modification agent is a hair colorant composition.

6. The device according to claim 1, wherein the applicator comprises a nozzle and a valve that can be opened and closed by a signal from the CPU.

7. The device according to claim 2, wherein the readings made by the sensor contain a value for a characteristic selected from the group of color, texture, and mixtures thereof.

8. A method for modifying a keratinous surface comprising the steps of:
providing a sensor that reads the properties of a small portion of the keratinous surface;
sending the readings to a CPU, which is programmed with a predetermined baseline value and at least one predetermined threshold value,
having the CPU compares the readings to the baseline value and calculates the variance between the reading and the baseline value;
when that calculated variance exceeds the threshold the CPU sends a signal to an applicator which is activated to apply a portion of a first modification composition to the same portion of the keratinous surface that had the reading with a variance above the threshold value.

9. The method according to claim 8, wherein the keratinous surface is selected from the group consisting of a hair shaft, a hair pore and mixtures thereof.
